(19) United States
(12) Patent Application Publication
(10) Pub. No.: US 2024/0388554 A1
(43) Pub. Date: Nov. 21, 2024

(54) METHOD OF PROVIDING CHAT SERVICE, SYSTEM AND COMPUTER PROGRAM IMPLEMENTING THE METHOD

(71) Applicant: Kakao Corp., Jeju-si (KR)

(72) Inventors: Eunju OH, Seongnam-si (KR); Suyeon KIM, Seongnam-si (KR); Min Ji SEO, Seongnam-si (KR); Kwang Wook LIM, Seongnam-si (KR)

(21) Appl. No.: 18/643,129

(22) Filed: Apr. 23, 2024

(30) Foreign Application Priority Data
May 17, 2023 (KR) 10-2023-0064038
Aug. 17, 2023 (KR) 10-2023-0107765

(51) Int. Cl. H04L 51/216; G06F 3/0481; H04L 51/04

(52) U.S. Cl. CPC H04L 51/216; H04L 51/04; G06F 3/0481

(57) ABSTRACT

Disclosed is an operating method of a user terminal, the operating method including: displaying a chat room provided by a chat service server, and receiving messages from said the chat service server, and visually distinguishing said messages according to elapsed time since the messages were received and displaying the messages in the chat room by visually distinguishing the messages according to elapsed time since the messages were received.

### CROSS-REFERENCE TO RELATED APPLICATION

This application claims priority to and the benefit of Korean Patent Application No. 10-2023-0064038 filed in the Korean Intellectual Property Office on May 17, 2023, and Korean Patent Application No. 10-2023-0107765 filed in the Korean Intellectual Property Office on Aug. 17, 2023, the entire contents of which are incorporated herein by reference.

### BACKGROUND

### (a) Field

The present disclosure relates to a chat service.

### (b) Description of the Related Art

Chat services provide an environment to engage in real-time communication through chat rooms, facilitating the exchange of messages. These chat services are not only available through instant messaging applications, such as KakaoTalk, but are also integrated into various online platforms, including gaming, social media, and business communication tools for communication of users.

In a chat room, messages from participants are displayed sequentially, with older messages pushing up as newer messages arrive, allowing users to scroll through and read them. However, solely relying on this sequential display in the chat room and the visual information displayed next to the message can make it challenging to discern the timing and authorship of messages intuitively.

### SUMMARY

The present disclosure attempts to provide a method of providing a chat service that visually distinguishes and displays messages as time passes, and a system and a computer program implementing the method.

An exemplary embodiment of the present disclosure provides an operating method of a user terminal, the operating method including: displaying a chat room provided by a chat service server; and receiving messages from the chat service server, and displaying the messages in the chat room by visually distinguishing the messages according to elapsed time since each message was received.

The displaying the messages in the chat room may include displaying the messages with colors changed according to the elapsed time.

The displaying the messages in the chat room may include displaying a recent message of which the elapsed time is within a predetermined time in a different color from a message of which the elapsed time is beyond the predetermined time.

The displaying the messages in the chat room may include differently providing a visual indication of the messages according to the elapsed time depending on a message's sender.

The displaying the messages in the chat room may include displaying a user message input on a message input window of the chat room and other participant message in the chat room by differently chaning the user message and the other participant message according to time.

The user message may be finally displayed with a different color from the other participant message.

The displaying the messages in the chat room may include differently setting message display attributes according to the elapsed time of the messages to display the messages in the chat room.

Another exemplary embodiment of the present disclosure provides a user terminal including: a memory for storing instructions; and at least one processor for executing the instructions. The processor by executing the instructions is configured to: display a chat room provided by a chat service server; and receive messages from the chat service server, and display the messages in the chat room by visually distinguishing the messages according to elapsed time since the each message was received.

The processor may be configured to display the messages with colors changed according to the elapsed timeg.

The processor may be configured to display a recent message of which the elapsed time is within a predetermined time in a different color from a message of which the elapsed time that is beyond the predetermined time.

The processor may be configured to differently provide a visual indication of the messages according to the elapsed time depending on a message's sender.

The processor may be configured to display a user message input on a message input window of the chat room and other participant message in the chat room by differently chaning the user message and the other participant message according to time.

The processor may be configured to finally display the user message with a different color from the other participant message.

The processor may be configured to differently set message display attributes according to the elapsed time of the messages to display the messages in the chat room.

Still another exemplary embodiment of the present disclosure provides a computer program stored in a computer-readable storage medium, the computer program comprising instructions for displaying a chat room provided by a chat service server; and receiving messages from the chat service server, and displaying the messages in the chat room by visually distinguishing the messages according to elapsed time since each message was received.

The displaying the messages in the chat room may include displaying the messages with colors changed according to the elapsed time.

The displaying the messages in the chat room may include displaying a recent messages of which the elapsed time is within a predetermined time in a different color from a message of which the elapsed time that is beyond the predetermined time.

The displaying the messages in the chat room may include differently providing a visual indication of the messages according to the elapsed time depending on a message's sender.

The displaying the messages in the chat room may include displaying a user message input on a message input window of the chat room and other participant message in the chat room by differently chaning the user message and the other participant message according to time.

The displaying the messages in the chat room may include differently setting message display attributes according to the elapsed time of the messages to display the messages in the chat room.

According to the embodiments, by visually distinguishing and displaying messages based on their receipt time, users can quickly identify the recent messages received in the chat room.

According to the embodiment, by visually distinguishing the messages written by the user from messages written by others, the user can quickly find his/her own messages whithin the chat room.

### BRIEF DESCRIPTION OF THE DRAWINGS

FIG. 1 is a schematic configuration diagram of a service system according to an embodiment.

FIGS. 2 and 3 are diagrams illustrating examples of a chat room interface screen according to the embodiment.

FIG. 4 is a diagram illustrating an example of an interface screen of a disappearing chat room associated with an article according to the embodiment.

FIG. 5 is a flow diagram illustrating a method of providing a chat service according to an embodiment.

### DETAILED DESCRIPTION OF THE EMBODIMENTS

Hereinafter, exemplary embodiments of the present disclosure will be described with reference to accompanying drawings so as to be easily understood by a person ordinary skilled in the art. The present disclosure can be variously implemented and is not limited to the following exemplary embodiments. In addition, in order to clearly explain the present description in the drawings, parts irrelevant to the description are omitted, and similar parts are denoted by similar reference numerals throughout the specification.

Throughout the specification, unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

A server may include one or more processors, memory for loading computer programs executed by the processors, storage devices for storing the computer programs and various data, and communication interfaces. In addition, the server may further include various components. A processor is a device that controls the operation of a server and may be various forms of processor that processes instructions contained in a computer program, and may include, for example, at least one of a Central Processing Unit (CPU), a Micro Processor Unit (MPU), a Micro Controller Unit (MCU), a Graphic Processing Unit (GPU), or any other form of processor well known in the art of the present disclosure. The memory stores various data, instructions, and/or information. The memory may load a corresponding computer program from the storage device such that the instructions described to execute the operations of the present disclosure are processed by the processor. The memory may be, for example, Read Only Memory (ROM) and Random Access memory (RAM). The storage devices may non-temporarily store computer programs and various data. The storage device may include a non-volatile memory, such as a Read Only Memory (ROM), an Erasable Programmable ROM (EPROM), an Electrically Erasable Programmable ROM (EEPROM), a flash memory, or the like, a hard disk, a removable disk, or any other form of computer-readable recording medium well known in the art to which the present disclosure belongs. The communication interface may be a wired/wireless communication module that supports wired/wireless communication. A computer program may include instructions executed by the processor, and may be stored on a non-transitory computer readable storage medium, and the instructions cause the processor to execute the operation of the present disclosure.

A terminal includes a computer/program, which is software stored on a computer-readable storage medium, and hardware, such as processors, memory, displays, and communication modules. The processor drives the computer program in corporation with hardwares. The display may display a screen of a user interface provided by the application, and may receive user input, for example, touch input. The communication module communicates with the server through a communication network. A computer program is software stored on a computer-readable storage medium and includes instructions and data to execute the operations of the present disclosure.

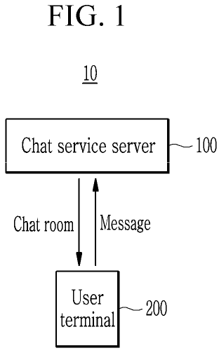

FIG. 1 is a schematic configuration diagram of a service system according to an embodiment.

Referring to FIG. 1, a service system 10 may include a chat service server 100 and a user terminal 200 communicating with the chat service server 100.

The chat service server 100 may be implemented on various online platforms that provide chat services, such as instant messaging service platforms, gaming platforms, social media platforms, and business communication platforms.

The user terminal 200 may be a mobile terminal, a personal computer (PC) such as a laptop computer, or any other type of computing device that is capable of accessing the chat service server 100, displaying interface screens provided by the chat service server 100, and receiving user input. While the description uses a mobile terminal as an example, the present disclosure is not limited thereto.

The user terminal 200 displays a chat interface via a computer program that is capable of communicating with the chat service server 100. The computer program may include an application provided by an online platform on which the chat service server 100 is implemented, a browser that is capable of accessing the chat service server 100, or the like.

The chat service server 100 opens a chat room and provides various information including messages displayed in the chat room, to the user terminal 200 that enters the chat room. The user terminal 200 displays messages transmitted to the chat room by chat room participants to the chat service server 100 in the chat room, and also sends messages input by the user to the chat service server 100. The chat service server 100 then transmits the messages input by the user to the terminals of the chat room participants, causing the user's messages to be displayed in the chat room.

On the other hand, users who are friends may enter a chat room and talk to each other, but like KakaoTalk's Open Chat service, which is an anonymous chat service, strangers may enter a chat room and exchange messages.

Similarly, the chat room is characterized in displaying messages written by participants in order, so as newer messages are sent, older messages are pushed up and newer messages are displayed in the places of the older messages. When many messages are sent at the same time, the messages are quickly pushed up on the screen, forcing users to scroll through them, and it is hard to intuitively tell which messages were sent newestly based on the visual information displayed next to the messages. This is true even when messages are sent occasionally, and unless the user keeps an eye on the chat room, it is hard to intuitively tell which messages are recent and whether there is no recent message based on the visual information displayed next to the message. A user may also scroll through his/her messages to see what he/she have written, but when there is a significant amount of accumulated messages, it may be difficult for the user to find the message written by himself/herself.

In order to solve the problems, the user terminal 200 may visually distinguish messages based on elapsed time after receiving the message and display the messages. For example, the user terminal 200 may display messages by changing the color of the message over time, such that the color becomes progressively lighter over time. For convenience, it is assume that the elapsed time is calculated from the receipt time by the user terminal. However, the elapsed time is determined by the server sending the messages or is calculated from the sending time.

The user terminal 200 may visually distinguish and display messages based on a sender of a message. The user terminal 200 may visually distinguish the messages by differently setting the display attributes of the messages, such as the message color (e.g., color of speech bubble), message shape (e.g., shape, size, or the like of speech bubble.), effects applied to the messages (e.g., blinking animation), text size, or font. For example, the user terminal 200 may visually distinguish the messages written by the user from messages written by other users and display the messages. The user terminal 200 may display messages written by the user in a particular color and messages written by other users in a different color. In addition, when the message was written by the user, the message fades over time from the initial color, so that the user terminal 200 displays the message in a final specified color, when the message was written by someone else, the message fades over time, and the user terminal 200 may finally display the message in white. This allows the user to easily find messages that the user has written through the color of the message while scrolling through the chat room, and to quickly determine whether the message is the newest in the chat room by looking at the color of the message. Additionally, the user terminal 200 may display messages written by a specific user among the participants in the chat room differently from messages written by other users. The specific user may be, for example, a user designated by the user in the chat service application, a user listed in the user's contacts, a user listed as a friend of the user, or a creator or administrator of the chat room. This allows the user to easily find messages written by people who the user is interested in.

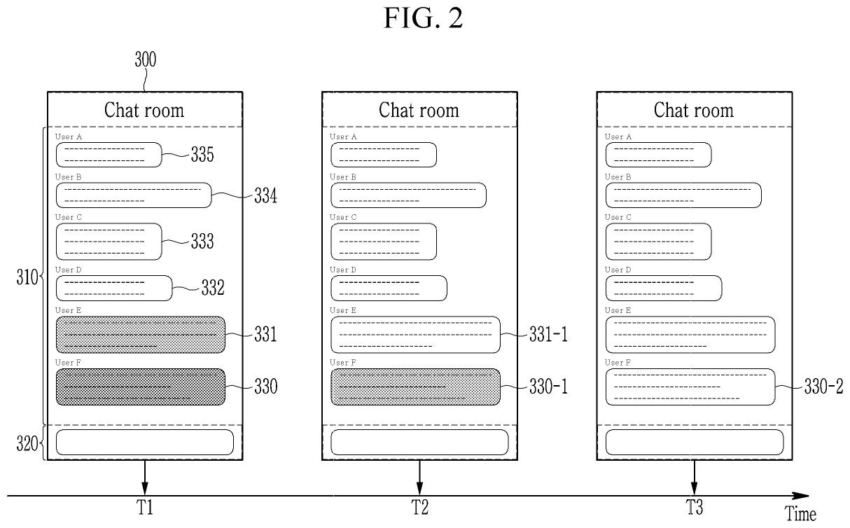

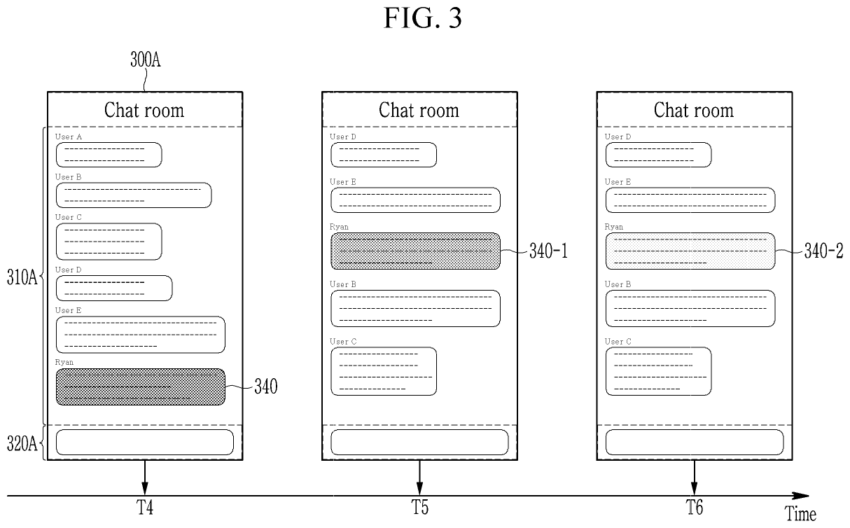

FIGS. 2 and 3 are diagrams illustrating examples of a chat room interface screen according to the embodiment.

Referring to FIG. 2, the user terminal 200 communicating with the chat service server 100 may display a chat room 300. The layout of the chat room 300 may vary, for example, the chat room 300 may include a message display window 310 that sequentially displays messages input by users who have entered the chat room, and a message input window 320 that allows users to input messages.

The user terminal 200 displays messages received from the chat service server 100 in the message display window 310, and may visually distinguish and display the messages according to the elapsed time after the time of receipt. For example, the user terminal 200 may display the message color by changing the message color over time, and the message color may change to progressively lighter color over time, and the step and time of the change may be designed to vary.

For example, when the current time point is time point T1, the user terminal 200 may display a UserF message 330 received from the chat service server 100 in the message display window 310, which may display the UserF message 330 in a first color specified for the recent message. A UserE message 331 may be displayed in a second color that is different from the first color because the elapsed time from the time of receipt to time point T1 (the current time) is within a predetermined time, and messages 332, 333, 334, and 335 that have an elapsed time from the time of receipt to time point T1 (the current time) that is longer than the predetermined time may be displayed in a third color. In this case, the first color, second color, and third color may be designated as progressively lighter colors, and the final color according to the change over time may be a particular color (e.g., white color).

At time point T2 after the set time from time point T1, the user terminal 200 may change the UserF message 330 displayed in the first color at time point T1 to a UserF message 330-1 in the second color at time point T2. The user terminal 200 may change the UserE message 331 displayed in the second color at time point T1 to a UserE message 331-1 in the third color at time point T2 and display the UserE message 331-1.

At time point T3, which is after the set time from time point T2, the user terminal 200 may change the UserF message 330-1 displayed in the second color at time point T2 to a UserE message 330-2 in the third color and display the UserE message 330-2.

In addition to color, the user terminal 200 may visually distinguish the newer messages by applying a flashing animation to the newer messages, and may display the newer messages with the size, font size, font type, and the like different from those of the older messages.

This allows the user to see the visually distinguished messages and intuitively know when the messages were received, especially recognize the recent message. Thus, even when the user terminal 200 receives and displays many messages at once, the user may immediately recognize that the messages in the first color are the recent messages while scrolling through the screen. Furthermore, the user may see a screen displaying only white messages and recognize that there are no recent messages, and when the message in the first color is displayed, the user may recognize that a participant has sent the recent message.

Referring to FIG. 3, the user terminal 200 communicating with the chat service server 100 may display a chat room 300A that includes a message display window 310A and a message input window 320A.

The user terminal 200 displays messages received from the chat service server 100 in the message display window 310A, and may visually distinguish the messages based on the sender of the message and display the messages. For example, the user terminal 200 may display the message color by changing the message color over time, and the message color may change to progressively lighter color over time, and the step and time of the change may be designed to vary.

For example, when the current time is time point T4, the user terminal 200 may display messages received from the chat service server 100 in the message display window 310A, and the message 340 input by the user Ryan in the message input window 320A at the current time (time point T4) may be displayed in the message display window 310A. Here, user Ryan's message 340 is described as being displayed in one direction (e.g., on the left side of the chat display window) like other users, but may display a speech bubble on the right side of the screen to indicate a conversation, or may omit the user's name. In this case, the user terminal 200 may display the message 340 in a specified color because the user's Ryan's message 340 is the recent message at the current time point. In this case, the user terminal 200 may visually distinguish the messages written by the user and the messages written by other users and display the messages. For example, the user terminal 200 may display the user Ryan's recent message 340 in a different color, such as a fourth color, from the color (first color) specified for other users' recent messages.

Alternatively, the user terminal 200 may display the recent messages in the same color (e.g., the first color) without distinguishment of the users, and progress with the color change differently depending on the user.

At time point T5, which is after the set time from time point T4, the user terminal 200 may change the Ryan's message 340 displayed in the fourth color at time point T4 to a message 340-1 in a fifth color and display the message 340-1. Then, at time point T6, which is after the set time from time point T5, the user terminal 200 may change the message 340-1 displayed in the fifth color at time point T5 to a message 340-2 in a sixth color and display the message 340-2. In this case, the fourth color, the fifth color, and the sixth color may be designated as progressively lighter colors, and the final color according to the change over time may not be white. That is, the user Ryan's message may continue to be displayed in the sixth color rather than white after time point T6.

In addition to color, the user terminal 200 may visually distinguish the user Ryan's message by applying a flashing animation to the user Ryan's message, and may display the user Ryan's message with different attributes, such as size, font size, and font type, from those of other users' messages.

In this way, by visually distinguishing and displaying the display attributes of the messages according to the message sender, the user Ryan may easily find the messages that he has written through the visually distinguished messages while scrolling through the chat room.

On the other hand, the user terminal 200 may display a message written by a specific user in the chat room among the participants of the chat room, other than the user himself, differently from messages written by other users. The user terminal 200 may set a user designated by the user as a specific user among the chat room participants, a user registered in the contacts among the chat room participants as a specific user, a user who is a friend among the chat room participants as a specific user, or a creator or administrator of the chat room as a specific user.

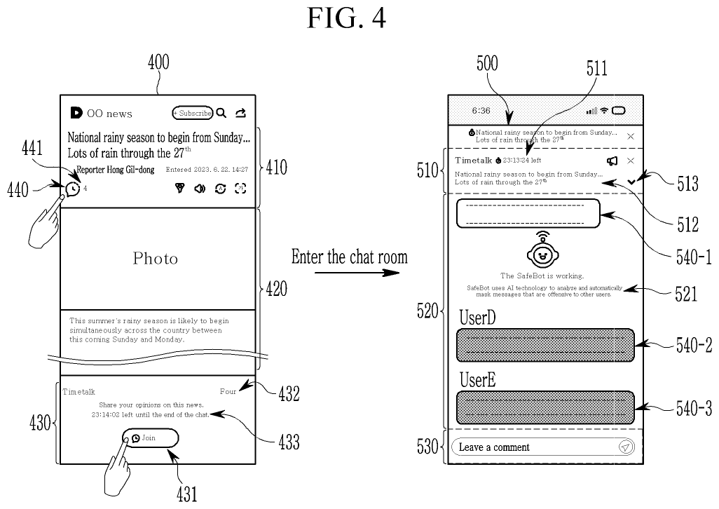

FIG. 4 is a diagram illustrating an example of an interface screen of a disappearing chat room associated with an article according to the embodiment.

Referring to FIG. 4, the user terminal 200 may communicate with servers (not illustrated) including the chat service server 100, and display selected articles among articles posted on the servers on an interface screen provided by an application or browser. These servers (not illustrated) may include the chat service server 100, and an article distribution server, for example. The servers may be configured in a variety of ways, and the operation between the configured devices may be defined in a variety of ways depending on the implementation.

The server may provide a commenting service that allows users to share and discuss opinions about posted articles. Specifically, the server may post an article, create a chat room in association with the article that persists for a period of time (e.g., 24 hours) and then disappears (a disappearing chat room), and provide a commenting service that allows users to enter the chat room through an entry point within the article, and to express and discuss opinions by inputting messages in the chat room. This may be called a disappearing chat-based commenting service.

The server may close the chat room and terminate the commenting service when the chat room's valid time has expired. The valid time of the chat room may be counted from the time point The article is made public, that is, from the time of posting (issuing), but the counting time or the valid time can be set in different ways. The server may set a timer for the valid time of the chat room as the counting point.

The layout of the news screen 400 may be configured in a variety of ways, for example, the news screen 400 may include a header area 410 that includes a title, reporter information, article creation time (input time), and the like, a body area 420 that includes a photo or article content, and a comment area 430.

Articles displayed on the news screen 400 may be associated with a chat room that persists for a period of time (e.g., 24 hours) after posting and then disappears, and a chat room entry point may be implemented as a selectable user interface (UI) component (icons, buttons, and the like) at various locations on the news screen 400. For example, the chat room entry point may be represented in the header area 410 of the article as a header icon 440 that links to the chat room. Alternatively, the chat room entry point may be implemented as a Join button 431 in the comment area 430 that links to the chat room. When the at least one entry point 440 or 431 provided on the news screen 400 is selected, the chat room associated with the article is displayed on the screen. That is, the user may read the article displayed on the news screen 400, enter the chat room associated with the article via the at least one entry point 440 or 431 provided on the news screen 400, see opinions of other users, and input the user's opinion.

The news screen 400 may inform the users of the chat room participation degree by displaying the number of messages 441 input in the chat room. The number of messages 441 in the chat room may be displayed at a location surrounding the header icon 440. The number of messages 432 in the chat room may also be displayed at a predetermined location in the comment area 430.

The news screen 400 may display the time remaining until the chat room ends. The remaining time may be displayed, for example, at a predetermined location 433 in the comment area 430. The time remaining until the chat room ends may be displayed visually differently depending on the time remaining. For example, the time remaining may be displayed in a different color or size depending on the time remaining to visually notify the end of the chat room. The remaining time or elapsed time may be displayed on the user interface (UI) component (icon, button, and the like) on which the chat room entry point is implemented.

On the other hand, after a certain amount of time (e.g., 24 hours) has passed since the article was posted, the server may close the chat room associated with the article and terminate the commenting service for the article. Thus, the news screen after the certain amount of time has passed since the article was posted may display the title, reporter information, article creation time, photo, or article content as before, but may not expose the comment area 430 associated with the chat room, or may display a message indicating that the comment service is terminated in place of the chat room information associated with the comment area 430. Additionally, the header icon 440 and the number of messages 441 in the chat room may disappear from the news screen.

When the at least one chat room entry point 440 or 431 is selected on the news screen 400, the user terminal 200 displays the disappearing chat room 500 associated with the article on the screen. The disappearing chat room 500 may pop up on top of the news screen 400, or in the case of a mobile terminal, may be displayed as a pop-up window that occupies most of the screen. In this case, the disappearing chat room 500 may pop up on top of a dimmed news screen.

The layout of the disappearing chat room 500 may vary, for example, the disappearing chat room 500 may include an information window 510 that provides the time remaining until the chat room ends and article information, a message display window 520 that sequentially displays messages input by users who have entered the disappearing chat room 500, and a message input window 530 that allows users to input messages. The information window 510 may be disposed in a header area that is an upper end of the message display window 520, and the message input window 530 may be disposed at a lower end of the message display window 520. Each of the information window 510, the message display window 520, and the message input window 530 configuring the disappearing chat room 500 may include functions implemented for the operation of the present disclosure, and each function may operate in conjunction with a server or may be programmed to operate on a user terminal. The information window may be implemented to be located in a partial area of the message display window (information providing area), and is not limited to the form exemplified in the present disclosure.

The information window 510 may display the time 511 remaining until the chat room ends and article information. The time 511 remaining until the chat room ends may change in real time. The information window 510 is limited in size so that essential information, such as the article title 512, may be exposed as article information to fit the size. Furthermore, the information window 510 may be implemented with an expanding and folding function, such that the basic area may be expanded and unfolded when the expanding function 513 is executed. The expanded information window may further display a summary of the article and may further display a path to the article body. When the folding function is executed in the expanded information window, the area may be reduced to an original size. In the meantime, an article summary needs not to be essential, and article summaries may not be provided for some articles.

The message display window 520 may display messages input in the message input window 530 by the users entering the disappearing chat room 500 in the form of chat messages (e.g., speech bubbles). In addition, a bot deployed in the disappearing chat room 500 may monitor the messages input by the users and control the corresponding content to be hided in the message display window 520 when inappropriate expressions, such as abusive language or forbidden words, are detected. To help the users recognize that the bot is operating, a bot notice 521 may be displayed in the message display window 520. The bot notice 521 may be exposed in a newest text location (e.g., at the bottommost end) each time a user enters the disappearing chat room 500, and may be pushed up like a message as new text is input.

The message display window 520 may visually distinguish the messages according to the elapsed time after the time of receipt and display the messages, as described with reference to FIGS. 2 and 3, and may visually distinguish and display the messages according to the sender of the message. For example, messages may change from an initial color to a fading color over time, and messages written by others fades over time but are finally displayed in white, and messages written by the user may continue to appear in the specified color even over time. Thus, messages 540-1 displayed in white indicate that the messages 540-1 are messages that have been received a certain amount of time ago. On the other hand, since messages 540-2 and 540-3 written by UserD and UserE are new messages that were recently received, the messages 540-2 and 540-3 may be displayed in a different color (e.g., the first color) from the previous messages to indicate that the messages 540-2 and 540-3 are recently received. In addition, the messages may be visually distinguished by differently setting the display attributes of the messages, such as message shape (e.g., shape, size, or the like of speech bubble), effects applied to the messages (e.g., blinking animation), text size, or font, in addition to the message color.

The message input window 530 may be implemented with a function of receiving text input by the user and transmitting the text to the server. The text transmitted by the user is displayed as a new message in the message display window 520. The message written by the user may be deleted through a menu that provides a delete function, or through a specified user action (e.g., swipe to delete).

In the case of the disappearing chat room 500, it may be configured to allow message transmission in a logged-in state or a real name verification state. The user terminal 200 may then check the login status or real name verification status and, when the user is not logged in or not real name verified, the user terminal 200 may inactivate a message input function of the message input window 530 and/or restrict the transmission of messages input in the message input window 530.

When there is a message transmission restriction condition set in the disappearing chat room 500, the user terminal 200 may determine whether the input message or the user who input the message corresponds to a transmission restriction condition, and may restrict the message input and/or restrict the message transmission.

When the input message or the user who input the message corresponds to the transmission restriction condition, the user terminal 200 may not transmit the message to the chat service server 100 and may display a guidance screen related to the message transmission restriction.

For example, the user terminal 200 may, through a text automatic input detection function, detect the behavior of repeatedly transmitting the same or similar text and display a message automatic input restriction notice without transmitting the message to the chat service server 100. Through a user detection function, the user terminal 200 may not transmit a message input by a user who is restricted from transmitting messages through a report and the like to the chat service server 100, and display a message writing restriction notice for the user. The user terminal 200 may, through a message writing count detection function, display a message writing count exceeded notice without transmitting a message to the chat service server 100 that exceeds a threshold number of times of the writing the messages. The user terminal 200 may, through a message consecutive writing detection function, display a message consecutive writing restriction notice without transmitting consecutively input messages to the chat service server 100.

Among various message transmission restriction conditions, under a condition in which a message transmission is not allowed for a certain amount of time, the user terminal 200 may restrict message input by inactivating the message input window 530, or restrict message input by displaying a screen indicating that message input is restricted when the message input window is selected. The expired disappearing chat room 500 is closed and the user can no longer view messages or input messages. Similarly, the server may close the chat room associated with the article and terminate the commenting service for the article. Thus, a news screen after a certain amount of time has passed since the article was posted may display only the article without exposing information related to the disappearing chat room.

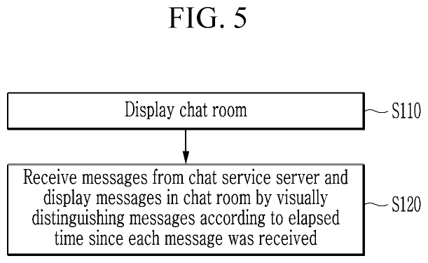

FIG. 5 is a flow diagram illustrating a method of providing a chat service according to an embodiment.

Referring to FIG. 5, the user terminal 200 displays a chat room (S110). Here, the user terminal 200 displays a chat interface screen via a computer program that is capable of communicating with the chat service server 100. The layout of the chat room may vary, for example, the chat room may include a message input window for users to input messages, and a message display window that sequentially displays messages input by users who have entered the chat room. The computer program may include an application provided by an online platform on which the chat service server 100 is implemented, a browser that is capable of accessing the chat service server 100, or the like.

The user terminal 200 receives messages from the chat service server 100 and displaying the messages in the chat room by visually distinguishing the messages according to elapsed time since each message was received (S120). For example, the user terminal 200 may display a message color while changing the message color over time, and the message color may change to progressively lighter color over time, and the step and time of the change may be designed to vary. The messages may be distinguished by differently setting the display attributes of the messages, such as message shape (e.g., shape, size, or the like of speech bubble), effects applied to the messages (e.g., blinking animation), text size, or font, in addition to the message color. In the meantime, the user terminal 200 may apply different display attributes to messages that change over time based on the sender of the message. For example, the user terminal 200 may provide the method of displaying messages written by the user over time and the method of displaying messages written by other users over time differently, such that after a certain period of time, the user terminal 200 may display the messages written by the user to be visually prominent in the chat room.

The user terminal 200 may include a memory storing instructions, and at least one processor executing the instructions, and the processor may provide the chat service described with reference to FIGS. 1 to 7 by executing the instructions. The instructions may be included in computer programs including applications or browsers. A computer program stored in a computer-readable storage medium contains instructions that are executed by a processor.

In this way, According to the embodiments, by visually distinguishing and displaying messages based on their receipt time, users can quickly identify the recent messages received in the chat room.

According to the embodiment, by visually distinguishing the messages written by the user from messages written by others, the user can quickly find his/her own messages whithin the chat room.

The exemplary embodiments of the present disclosure described above are not only implemented through the apparatus and method, but may also be implemented through programs that realize functions corresponding to the configurations of the exemplary embodiment of the present disclosure, or through recording media on which the programs are recorded.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

What is claimed is:

1. An operating method of a user terminal, the operating method comprising:
displaying a chat room provided by a chat service server; and
receiving messages from the chat service server, and displaying the messages in the chat room by visually distinguishing the messages according to elapsed time since each message was received.

2. The operating method of claim 1, wherein the displaying the messages in the chat room includes
displaying the messages with colors changed according to the elapsed time.

3. The operating method of claim 2, wherein the displaying the messages in the chat room includes
displaying a recent message of which the elapsed time is within a predetermined time in a different color from a message of which the elapsed time that is beyond the predetermined time.

4. The operating method of claim 1, wherein the displaying the messages in the chat room includes
differently providing a visual indication of the messages according to the elapsed time, depending on a message's sender.

5. The operating method of claim 4, wherein the displaying of the messages in the chat room includes
displaying a user message input on a message input window of the chat room and other participant message in the chat room by differently chaning the user message and the other participant message according to time.

6. The operating method of claim 5, wherein the user message is finally displayed with a different color from the other participant message.

7. The operating method of claim 1, wherein the displaying the messages in the chat room includes
differently setting message display attributes according to the elapsed time of the messages to display the messages in the chat room.

8. A user terminal comprising:
a memory for storing instructions; and
at least one processor for executing the instructions,
wherein the processor by executing the instructions is configured to:
display a chat room provided by a chat service server; and
receive messages from the chat service server, and display the messages in the chat room by visually distinguishing the messages according to elapsed time since the each message was received.

9. The user terminal of claim 8, wherein the processor is configured to
display the messages with colors changed according to the elapsed timeg.

10. The user terminal of claim 9, wherein the processor is configured to
display a recent message of which the elapsed time is within a predetermined time in a different color from a message of which the elapsed time that is beyond the predetermined time.

11. The user terminal of claim 8, wherein the processor is configured to
differently provides a visual indication of the messages according to the elapsed time depending on a message's sender.

12. The user terminal of claim 11, wherein the processor is configured to
display a user message input on a message input window of the chat room and other participant message in the chat room by differently chaning the user message and the other participant message according to time.

13. The user terminal of claim 12, wherein the processor is configured to
finally display the user message with a different color from the other participant message.

14. The user terminal of claim 8, wherein the processor is configured to
differently set message display attributes according to the elapsed time of the messages to display the messages in the chat room.

15. A computer program stored in a computer-readable storage medium, the computer program comprising instructions for:
displaying a chat room provided by a chat service server; and
receiving messages from the chat service server, and displaying the messages in the chat room by visually distinguishing the messages according to elapsed time since each message was received.

16. The computer program of claim 15, wherein the displaying the messages in the chat room includes
displaying the messages with colors changed according to the elapsed time.

17. The computer program of claim 16, wherein the displaying the messages in the chat room includes
displaying a recent messages of which the elapsed time is within a predetermined time in a different color from a message of which the elapsed time that is beyond the predetermined time.

18. The computer program of claim 15, wherein the displaying the messages in the chat room includes
differently providing a visual indication of the messages according to the elapsed time depending on a message's sender.

19. The computer program of claim 18, wherein the displaying the messages in the chat room includes
displaying a user message input on a message input window of the chat room and other participant message in the chat room by differently chaning the user message and the other participant message according to time.

20. The computer program of claim 15, wherein the displaying the messages in the chat room includes
differently setting message display attributes according to the elapsed time of the messages to display the messages in the chat room.
